(19) United States
(12) Patent Application Publication
(10) Pub. No.: US 2009/0141853 A1
(43) Pub. Date: Jun. 4, 2009

(54) PROTECTIVE SHIELD FOR CT SCANNING MACHINE

(76) Inventor: Veronica Crews, Houston, TX (US)

Correspondence Address: SCHIFF HARDIN, LLP;PATENT DEPARTMENT, 6600 SEARS TOWER, CHICAGO, IL, 60606-6473, US

(21) Appl. No.: 12/258,538

(22) Filed: Oct. 27, 2008

Related U.S. Application Data
(60) Provisional application No. 61/004,850, filed on Nov. 30, 2007.

(51) Int. Cl. H05G 1/02; B32B 3/06

(52) U.S. Cl. 378/4; 428/99

(57) ABSTRACT

The protective shield protects a computerized tomography (CT) scanning machine from liquids and other contaminants that may spill or leak during the scanning process. The protective shield, for example, includes a central section that provides for easy positioning in and covering of the gantry opening of the CT scanning machine. The central section, for example, has outer edges with a plurality of hinged panels allowing the protective shield to sit generally flush against the CT scanning machine.

### RELATED APPLICATION

The present application claims the benefit of Provisional Application Ser. No. 61/004,850 filed on Nov. 30, 2007

### TECHNICAL FIELD

The description herein relates to a protective shield, such as a removable protective shield, for use on a scanner. For example, the protective shield may be used on a whole body positron emission tomography scanner, although the protective shield can be used with other scanners as well. The protective shield protects, for example, the gantry of the scanner.

### BACKGROUND

Computerized Tomography (CT) scanning is a powerful diagnostic technique that provides medical personnel detailed images relating to the location of physiological abnormalities, which in some cases may need to be removed. As a diagnostic tool, CT scanning is frequently utilized after a patient has manifested clinical symptoms of a disease. Additionally, CT scanning may be utilized before and after surgical procedures to ascertain both the need for the operation and, later, the success of the procedure.

Patients undergoing CT scanning procedures are, in some cases, administered medications intravenously. Additionally, the patient may have catheters or other equipment carrying liquids in place, and in some cases may have contrast materials administered by enema. It is not uncommon for liquid from these sources and/or bodily fluids from the patient to leak onto the CT's gantry and contaminate imaging equipment through the gantry slot. The liquids leaking onto the imaging equipment can cause substantial damage to the imaging equipment, resulting in increased costs for maintenance, repair, and parts.

Accordingly, it would be advantageous to protect the imaging equipment of the CT scanning machine from liquids and other contaminants leaking through the gantry of the CT scanning machine.

The protective shield described herein protects a computerized tomography scanning machine from liquids and other contaminants that may spill or leak during the scanning process. One embodiment contemplates the continuous use of the protective shield to protect the scanner's imaging equipment. Another embodiment contemplates a protective shield that may be removed from the CT scanning machine after each use. A further embodiment contemplates a protective shield that can be sterilized and reused between uses. A still further embodiment contemplates a disposable protective shield that is to be discarded after a single use. Other and additional embodiments will become apparent from a consideration of this entire specification.

### BRIEF DESCRIPTION OF THE DRAWINGS

The above and other features, aspects, and/or advantages of the protective shield described herein are considered in more detail in relation to the following accompanying drawings in which:

FIG. 1 is a perspective front view of a CT scanning machine with a protective shield therein;

FIGS. 2 is an illustration of the protective shield of FIG. 1 before application to the CT scanning machine; and,

FIG. 3 is an illustration of one of the hinged panels that hold the protective shield in place.

### DETAILED DESCRIPTION

The protective shield may be better understood by referring to the following description, which should be read in conjunction with the accompanying drawings in which like reference numbers are used for like parts. The description of the shield herein is to enable the making and use of an implementation of the protective shield, is not intended to be limited to any particular embodiment of a protective shield, but is to serve as a particular example thereof. Those skilled in the art should appreciate that they may readily use the conception and specific embodiments disclosed herein as a basis for modifying or designing other methods and systems for carrying out the same purposes of the protective shield. Those skilled in the art should also realize that such equivalent assemblies do not depart from the spirit and scope of the shield in its broadest form.

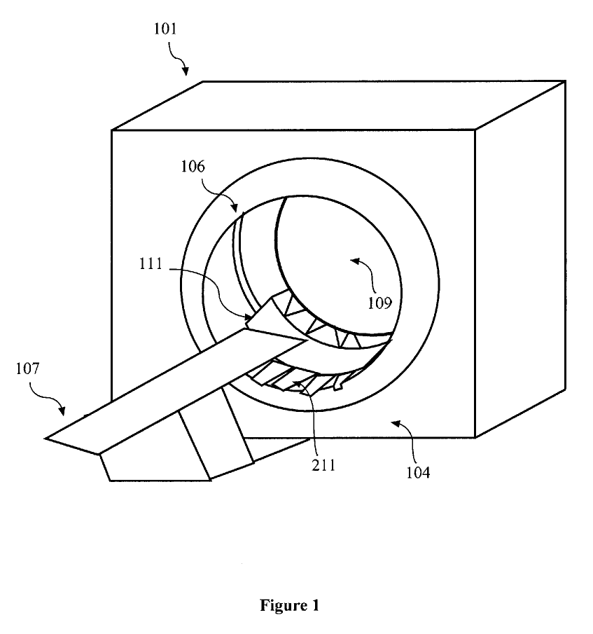

As shown in FIG. 1, a CT scanning machine 101 generally comprises a CT gantry 104 and a patient table 107. The CT scanning machine 101 includes a patient receiving chamber 109 into which a patient on the patient table 107 is inserted for conducting diagnostic procedures on the patient. The CT gantry 104 has a gantry opening 106 around at a least of the perimeter of the patient receiving chamber 109. The gantry opening 106, for example, may be in the form of the slot shown in FIG. 1. The gantry opening 106 permits X-rays to be emitted and to be recorded by the imaging equipment of the CT scanning machine 101.

In one embodiment, a protective shield 111 is configured for insertion into the patient receiving chamber 109 of the CT gantry 104 of the CT scanning machine 101 in order to protect the imaging equipment, which is exposed through the gantry opening 106 in the patient receiving chamber 109 of the CT scanning machine 101, from contaminants such as fluid or run-off from the patient or the patient table 107 or otherwise.

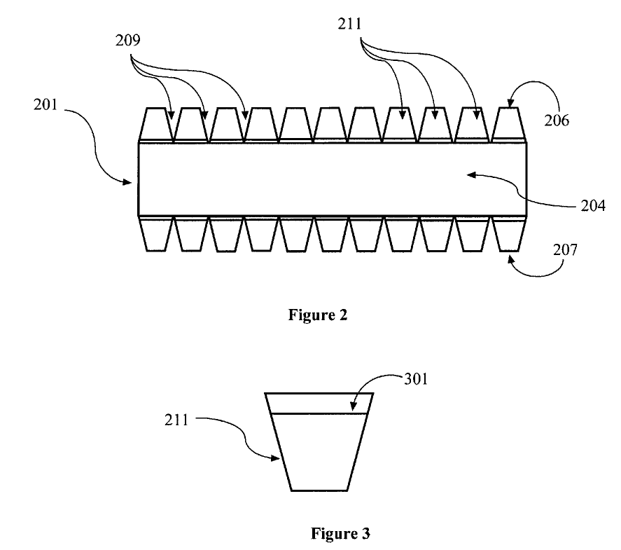

According to one embodiment of the protective shield 111, an elongated sheet 201 shown in FIG. 2 has a central section 204 with a width and a length sufficient to cover that portion of the gantry opening 106 through which contaminants might otherwise pass from the patient to the imaging equipment of the CT scanning machine 101. Before application of the protective shield 111 to the CT scanning machine 101, the central section 204 appears to be planar as shown in FIG. 2. Outer edges 206 and 207 of the elongated sheet 201 are formed with a plurality of cuts 209 extending from the outer edges 206 and 207 inwardly towards the central section 204, thus creating a plurality of hinged panels 211 at the outer edges 206 and 207.

As shown in FIG. 1, the hinged panels 211 allow the outer edges 206 and 207 of the protective shield 111 to sit substantially flush against the front and back contours of the CT scanning machine 101 at the outside front and back faces adjacent the patient receiving chamber 109, which is typically curved or angled adjacent the relatively cylindrical center portion of the CT scanning machine 101. Thus, should contaminants drop down from the patient table 107, the fluid will impact the protective shield 111 and simply run off of onto the floor instead of entering the CT gantry 104 through the gantry opening 106 and potentially fouling the imaging equipment.

However, if desired, instead of the outer edges 206 and 207 being coextensive with the front to back depth of the patient receiving chamber 109 between the front and back faces of the CT scanning machine 101, the hinged panels may be long enough that the outer edges 206 and 207 jut out of the CT machine at least somewhat to facilitate run off of contaminants dropping down from the patient table 107.

Instead of being flush with the outside faces of the CT scanning machine 101, the hinged panels 211 at the outer edges 206 and 207 of the protective shield 111 may, as desired, extend somewhat outside of the CT gantry 104 to facilitate the run off of contaminants. Also, in the case wherein the patient receiving chamber 109 is curved as shown in FIG. 1, the protective shield 111 bends during application to follow the contour of the patient receiving chamber 109. This bending of the protective shield 111 causes the hinged panels 211 to also curve forming funnels that channel the contaminants out of the CT scanning machine 101.

A representative one of the hinged panels 211 is shown in FIG. 3 and may be constructed in any number of ways. In one embodiment of the protective shield 111, the hinged panels 211 consist of pockets with open slots 301. The open slots 301 allow weights to be loaded into the pockets of the hinged panels 211. The weights may add to the weight of the protective shield 111 so as to assist in holding the protective shield 111 in place within the patient receiving chamber 109 so that the protective shield is not fastened to the CT scanning machine 101 by fasteners such as screws, clips, etc. For instance, such weights may include sand, silicone, small pellets of different sizes and other materials that, through their weight, allow the protective shield 111 to remain in place.

It is also contemplated that the open slots 301 of the hinged panels 211 may be sealed after the weight material is added to the pockets. Alternatively, the open slots 301 may be re-sealable so as to permit the weight material to be replaced from time to time. As a further alternative, the hinged panels 211 may be formed of a distinct material with a sufficient thickness and/or weight to hold the protective shield 111 in place during use. As still a further alternative, the hinged panels 211 may be formed with no pockets and of the same materials and thickness as the remainder of protective shield 111.

According to one embodiment, the protective shield 111 may be disposable so that it can be discarded after a single use. In this case, the protective shield 111 is preferably formed of inexpensive material. For example, the protective shield 111 may be formed from a thermoplastic sheet. The protective shield 111 also is preferably formed of a flexible material so that the protective shield 111 can be applied to follow the shape of the patient receiving chamber 109. However, the protective shield 111 may be formed from other materials, either synthetic or natural. It is contemplated that the protective shield 111 may also be utilized continuously. In this case, the material of the protective shield 111 is such that the protective shield 111 can be sterilized and reused as needed.

The protective shield 111 may be constructed of a number of different materials, such as plastics, that do not interfere with the emissions of the CT machine. In another embodiment, it is contemplated that the protective shield 111 may be fastened to the sides of the CT machine through the use of, for example, hook and loop fasteners, snaps, or other types of fasteners that may be attached to the portion, such as the lower portion, of the CT gantry 104 to which the protective shield 111 is applied. Although FIG. 1 shows the protective shield 111 extending around only a lower portion of the patient receiving chamber 109, the protective shield 111 may be applied to the CT scanning machine 101 so that the protective shield 111 extends substantially around the patient receiving chamber 109 in case the contaminants spatter instead of just drop.

As described above, the protective shield 111 allows contaminants such as fluid to simply run off of onto the floor near the CT scanning machine 101. Alternatively, the central section 204 of the protective shield 111 can be provided as an absorbent material to absorb the contaminants such as fluid. In this case, the central section 204 of the protective shield 111 may be provided as a two or more ply section having an inner absorbing ply that absorbs traps or absorbs contaminants such as fluid and an outer fluid impervious ply that prevents the contaminants such as fluid from passing out of the protective shield 111 and through the gantry opening 106. As a further alternative, contaminant collectors may be provided at the ends of the hinged panels 211 to collect the contaminants such as fluid before the contaminants reach the floor.

While specific values, relationships, materials and/or steps have been set forth for purposes of describing concepts of the protective shield 111, it will be appreciated by persons skilled in the art that numerous variations and/or modifications may be made to the protective shield 111 as shown in the specific embodiments without departing from the spirit or scope of the basic concepts and operating principles of the protective shield 111 as broadly described. It should be recognized that, in the light of the above teachings, those skilled in the art can modify those specifics without departing from the invention as recited in the claims below. Having now fully set forth embodiments and certain modifications of the concept underlying the protective shield 111, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the protective shield 111 may be practiced otherwise than as specifically set forth herein. Consequently, the present embodiments are to be considered in all respects as illustrative and not restrictive.

What is claimed is:

1. A removable protective shield for a CT scanning machine comprising:
a central section arranged to cover at least a portion of an opening between a patient receiving chamber in a gantry of the CT scanning machine and imaging equipment of the CT scanning machine when the removable protective shield is applied to the CT scanning machine; and,
a panel hinged to the central section, wherein the hinged panel is arranged to convey contaminants from the central section and away from the opening.

2. The removable protective shield of claim 1 wherein the hinged panel is weighted so as to hold the removable protective shield in place within the gantry of the CT scanning machine so as to cover the opening.

3. The removable protective shield of claim 2 wherein the hinged panel includes a pocket that is configured to contain material that increases a weight of the removable protective shield so as to hold the removable protective shield in place within the gantry of the CT scanning machine.

4. The removable protective shield of claim 3 wherein the pocket comprises a slot thought which the material can be inserted into the pocket.

5. The removable protective shield of claim 4 wherein the slot is re-sealable.

6. The removable protective shield of claim 1 wherein the removable protective shield comprises a single-use disposable protective shield.

7. The removable protective shield of claim 1 wherein the hinged panel is arranged to carry contaminants to an exterior of the patient receiving chamber.

8. The removable protective shield of claim 1 further comprising a plurality of additional panels hinged to the central section, wherein the additional hinged panels are arranged to convey contaminants from the central section and away from the opening.

9. The removable protective shield of claim 8 wherein some of the panels are hinged to one side of the central section, and wherein others of the panels are hinged to an opposing side of the central section.

10. The removable protective shield of claim 1 wherein the removable protective shield comprises a fastenerless removable protective shield.

11. A CT scanning machine comprising:
a gantry;
a patient receiving chamber within the gantry;
an opening though the gantry between the patient receiving chamber and an exterior of the patient receiving chamber; and,
a fastenerless removable protective shield covering the opening so as to prevent contaminants from passing through the opening.

12. The CT scanning machine of claim 1 wherein the fastenerless removable protective shield comprises a hinged panel weighted so as to hold the fastenerless removable protective shield in place within the gantry so as to cover the opening.

13. The CT scanning machine of claim 12 wherein the hinged panel includes a pocket that is configured to contain material that increases weight of the fastenerless removable protective shield so as to hold the fastenerless removable protective shield in place within the gantry.

14. The CT scanning machine of claim 13 wherein the pocket comprises a slot thought which the material can be inserted into the pocket.

15. The CT scanning machine of claim 14 wherein the slot is re-sealable.

16. The CT scanning machine of claim 11 wherein the fastenerless removable protective shield comprises a disposable and fastenerless removable protective shield.

17. The CT scanning machine of claim 11 wherein the hinged panel is arranged to carry contaminants to an exterior of the patient receiving chamber.

18. The CT scanning machine of claim 11 further comprising a plurality of panels hinged to a central section of the fastenerless removable protective shield, wherein the hinged panels are arranged to convey contaminants from a central section of the fastenerless removable protective shield and away from the opening.

19. The CT scanning machine of claim 18 wherein some of the panels are hinged to one side of the central section, and wherein others of the panels are hinged to an opposing side of the central section.

20. A removable protective shield for a CT scanning machine comprising:
a central section arranged to cover at least a portion of an opening between a patient receiving chamber in a gantry of the CT scanning machine and imaging equipment of the CT scanning machine when the removable protective shield is applied to the CT scanning machine, wherein the central section is arranged to prevent contaminants from passing through the opening; and,
a plurality of panels hinged on either side of the central section, wherein the hinged panels are arranged to retain the removable protective shield within the patient receiving chamber without reliance on fasteners.

21. The removable protective shield of claim 20 wherein the removable protective shield comprises a single-use disposable protective shield.
